(19) United States
(12) Patent Application Publication
(10) Pub. No.: US 2001/0056537 A1
(43) Pub. Date: Dec. 27, 2001

(54) Probabilistic digital signature method

(76) Inventors: David Naccache, Paris (FR); Jacques Stern, Paris (FR); Pascal Paillier, Paris (FR)

Correspondence Address: BURNS DOANE SWECKER & MATHIS L L P, POST OFFICE BOX 1404, ALEXANDRIA, VA, 22313-1404, US

(21) Appl. No.: 09/802,968

(22) Filed: Mar. 12, 2001

(30) Foreign Application Priority Data
Mar. 28, 2000 (FR) 00/03918

(51) Int. Cl. H04L 9/00

(52) U.S. Cl. 713/180; 713/176

(57) ABSTRACT

A method relating to probabilistic digital signatures of a message, between a signatory and a checker, uses an algorithm based on the calculation of a discrete logarithm. For the signatory, at least two signatures are generated for the same unchopped message, these signatures being calculated by the algorithm by means of the same public and private key parameters using respectively distinct random values. For the checker, all the signatures of the message are checked.

This disclosure is based upon, and claims priority from, French Application No. 00/03918, filed Mar. 28, 2000, the contents of which are incorporated herein by reference.

### BACKGROUND OF THE INVENTION

The present invention concerns a method of generating probabilistic digital signals to enable the integrity of a transmitted message to be checked.

The present invention applies in particular to the field of chip cards, e.g. smart cards, with or without contacts. Such cards constitute protected information carriers and generally include a microcontroller incorporated on an integrated-circuit chip. A microcontroller has an architecture similar to that of a computer. It has a processing unit consisting of a microprocessor or CPU associated with different types of memory. A non-volatile memory, of the ROM type for example, generally has at least one program for implementing a signature algorithm.

The invention applies in particular to algorithms for generating and checking digital signatures. The objective of such algorithms is to calculate one or more integers, in general a pair, referred to as the signature and associated with a given message in order to certify the identity of the signature and the integrity of the signed message. Such algorithms make it possible on the one hand to generate signatures and on the other hand to check these signatures.

The signature is said to be probabilistic when the algorithm uses a random number in the generation of the signature, this random number being secret and regenerated with each new signature. Thus one and the same message transmitted by the same user can have several distinct signatures.

An example of such an algorithm can be illustrated by the DSA (Digital Signature Algorithm).

The parameters of the DSA are:

p, a large known prime number, of 512 or 1024 bits,

q, a prime number which divides p-1, of 160 bits,

g, an integer chosen such that g_{q}=1 mod p with g≠1 mod p.

The secret key x is a randomly fixed number between 0 and 2¹⁶⁰−1, and the public key is related therein to x by the equation y=g^{x} mod p.

The message to be sent is identified as m. The DSA signature of m is the pair (r,s) defined as follows:

r=(g^{k} mod p) mod q;

s=(h(m)+r·x)/k mod q;

with k a random number of 160 bits such that k<q, regenerated with each signature,

and h(m) the initial message m encoded by means of a chopping function which is a pseudo-random cryptographic function.

The signature is verified as follows:

A first intermediate calculation is performed w=s⁻¹ mod q.

It is checked whether ((g^{w-h(M)}y^{r·w}) mod p) mod q=r.

If this equality is true, the signature is authentic.

The signature (r,s) was generated with the secret key x and a secret random number k different for each signature, and it was checked with the public key y. Thus anyone can authenticate a card and its bearer without holding its secret key.

The use of the chopping function in generating the signature is found in almost all probabilistic signature generating algorithms based on a discrete logarithm calculation. It makes it possible to guarantee the non-reproducibility of the signature by breaking its linearity.

The use of this chopping function nevertheless has drawbacks since it assumes firstly that this function h behaves like a random function, which is not always true, and secondly that this function h is implemented in the memory of the integrated-circuit chip of the protected device (the chip card for example). However, the code size necessary for implementing the chopping function is very high, approximately 1 to 2 kilobytes.

The economic constraints related to the chip card market require constant research with a view to controlling its cost. This effort often consists of the use of simpler components. In such a context, the implementation of public key algorithms on inexpensive microcontrollers of the 8-bit type with an 8051 (Intel) or 6805 (Motorola) kernel, for example, represents an increasing advantage. It is, however, not possible to implement a digital signature algorithm such as the DSA or of the same type having recourse to a chopping function on such microcontrollers.

The aim of the invention is to resolve these constraints by proposing a solution which is adapted to microcontrollers having few calculation resources.

### DESCRIPTION OF THE INVENTION

The object of the present invention is a method of generating probabilistic digital signatures which makes it possible to dispense with the chopping function, without impairing the security of the messages exchanged.

To this end the invention proposes a method for transforming a probabilistic signature algorithm using a chopping function into another algorithm not using this function. To this end, the initial probabilistic algorithm is used twice instead of once to sign the message directly, that is to say the initial unchopped message. In this way twin signatures associated with the same message are generated.

The invention concerns more particularly a method relating to probabilistic digital signatures of a message, between a signatory and a checker, using an algorithm based on the calculation of a discrete logarithm. The method includes the step, for the signatory, of generating at least two signatures for the same unchopped message, these signatures being calculated by the algorithm by means of the same public and private key parameters using respectively distinct random values. The method further includes, for the checker, the step of checking all the signatures of the message.

According to one application, the probabilistic algorithm is the DSA (Digital Signature Algorithm).

According to another application, the probabilistic algorithm is the Schnorr algorithm.

The invention advantageously applies to any protected device of the chip card type, and in particular to devices having an 8-bit microcontroller.

The method according to the invention has the advantage of dispensing with the chopping function and thus minimizing the memory utilization. In addition, the calculation speed is increased, even if a double calculation is required. This is because using a chopping function is tricky on simple 8-bit microcontrollers, which are inexpensive and are often being used more and more in order to contain the manufacturing costs of the devices.

In addition, the method according to the invention guarantees security in the execution of any probabilistic digital signature generating algorithm.

The description refers to the DSA signature algorithm, but also applies to all other probabilistic signature algorithms and to their variants such as El Gamal, Schnorr, EC-DSA or Abe-Okamoto, for example, which also use the chopping function in generating pairs of signatures.

The signature generation method according to the invention is based on the calculation of at least two signatures, which are then referred to as twins, for the same initial unchopped message m. The signature thus comprises at least two signatures calculated by means of the same public key y and private key x parameters using respectively distinct random numbers k₁, k₂, . . . kₙ.

The message signature thus becomes (r₁,s₁,r₂,s₂, . . . rₙ,sₙ), with the n pairs (r₁, s₁) (for i ranging from 1 to n) calculated and checked in accordance with the conventional signature generation and checking methods, whether it is a case of the DSA, Schnorr or any other algorithm using a chopping function.

What is claimed is:

1. A method relating to probabilistic digital signatures of a message, between a signatory and a checker, using a probabilistic algorithm based on the calculation of a discrete logarithm, comprising the steps of:
for the signatory, generating at least two signatures (r₁,s₁) and (r₂,s₂) for the same unchopped message, said signatures being calculated by the algorithm by means of the same public and private key parameters using respectively distinct random values and, and
for the checker, checking all the signatures (r₁,s₁) and (r₂,s₂) of said message.

2. A method according to claim 1, wherein the probabilistic algorithm is the Digital Signature Algorithm.

3. A method according to claim 1, wherein the probabilistic algorithm is the Schnorr algorithm.

4. A protected device of the chip card type, having an electronic component that implements a signature method between a signatory and a checker, using a probabilistic algorithm based on the calculation of a discrete logarithm, that includes the steps of:
for the signatory, generating at least two signatures (r₁,s₁) and (r₂,s₂) for the same unchopped message, said signatures being calculated by the algorithm by means of the same public and private key parameters using respectively distinct random values and, and
for the checker, checking all the signatures (r₁,s₁) and (r₂,s₂) of said message.

5. A device according to claim 4, wherein the electronic component is an 8-bit microcontroller.
